(19) United States
(12) Patent Application Publication
(10) Pub. No.: US 2003/0022613 A1
(43) Pub. Date: Jan. 30, 2003

(54) Processing chamber

(76) Inventor: Robert G. Breukelman, Sioux Falls, SD (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/178,059

(22) Filed: Jun. 20, 2002

Related U.S. Application Data
(60) Provisional application No. 60/299,544, filed on Jun. 20, 2001.

(51) Int. Cl. A22C 25/02

(52) U.S. Cl. 452/173

(57) ABSTRACT

A processing chamber effective for workers to perform therein a selected task upon an edible product. The processing chamber comprises a floor, walls, and a ceiling joined together to be impermeable to water. The processing chamber further comprises a washing system which, when activated at regular intervals in the absence of the workers, directs a pressurized fluid toward at least one object within the processing chamber. The pressurized fluid washes away debris and sanitizes the at least one object. Upon sanitizing, the workers re-enter the chamber to perform the selected task upon the edible product.

### CROSS-REFERENCE TO RELATED APPLICATION(S)

Applicant claims the priority date of U.S. Provisional Application 60/299,544 filed on Jun. 20, 2001.

### BACKGROUND OF THE INVENTION

The present invention relates to a chamber used in the food industry. In particular, the present invention relates to a processing chamber for use in a livestock processing facility.

During the processing of edible products for human consumption, it is extremely important that proper sanitation methods be practiced in order to maintain high quality products for the consumer that are free from bacteria, pathogens and other micro-organisms. Products containing bacteria and pathogens, if consumed, can lead to sickness, malaise and the spread of other diseases.

Conventional processing facilities currently employ a variety of methods to maintain the sanitization of the facilities. These methods, however, are inefficient in that a considerable amount of “down time” takes place in order to maintain the strict sanitization requirements, often imposed by both the USDA and the FDA. Thus, in order to maximize production, the intervals between cleansing are maximized or lengthened to a point where the likelihood of contamination at the end of the interval is substantially greater than the likelihood of contamination at the beginning of the interval.

Conventional processing facilities typically perform “washdowns” between shifts or at the end of the day. A shift can typically last for 8 hours or more. However, it has been shown that bacteria and other pathogens within such facilities increase at an exponential rate after about four hours, vastly increasing the chance that the carcasses may be infected with such pathogens.

### BRIEF SUMMARY OF THE INVENTION

A processing chamber effective for workers to perform selected tasks upon a an edible product. The processing chamber comprises a floor, a ceiling and sidewalls joined together to be impermeable to water, and an automatic washing system effective for sanitizing or sterilizing the processing chamber. The washing system is activated at regular intervals in the absence of the workers to direct pressurized water toward at least one object within the processing chamber. Upon sanitizing or sterilizing, workers re-enter the processing chamber to perform the selected tasks upon the edible products.

### BRIEF DESCRIPTION OF THE DRAWINGS

FIG. 1 is a perspective view of an outward structure of a processing chamber of the present invention.

FIG. 2 is a perspective view of the processing chamber of the present invention during the processing of carcasses.

FIG. 3 is a perspective view of the processing chamber of the processing area of the present invention during a washing cycle.

FIG. 4 is a perspective view of the processing chamber of the processing area of the present invention.

FIG. 5 is a perspective view of an alternative embodiment of the processing chamber of the present invention.

### DETAILED DESCRIPTION

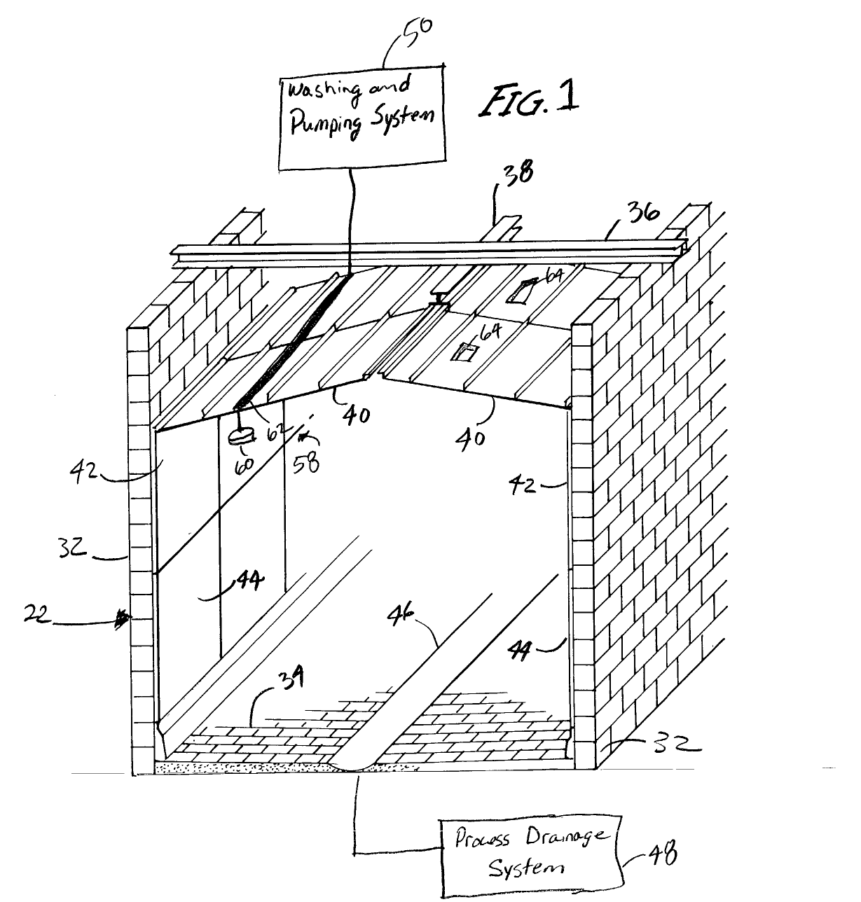

A processing chamber of the present invention is generally indicated at 10 in FIG. 1. In the preferred embodiment of the present invention, the processing chamber is used as a carcass work-up chamber within a livestock processing facility. A full and detailed description of the livestock processing facility employing the processing chamber of the present invention is included in U.S. Application No. (H565.12-01), incorporated herein by reference. Alternative embodiments of the present invention include use of the processing chamber within any facility for processing edible products where sterilization is preferred or required to minimize the spread of pathogens onto the edible products. Examples of such edible products include, but are not limited to, fruits and vegetables. For the sake of convenience, the preferred embodiment of the carcass work-up chamber will be discussed herein, but it should be understood that any edible food product can be replaced with the animal carcasses throughout the present description.

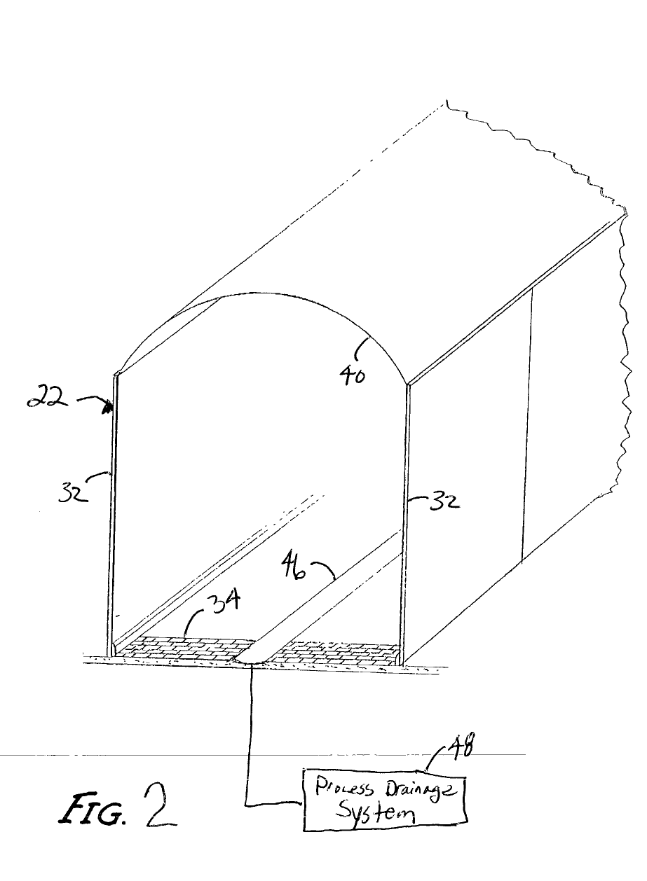

The processing chamber (also termed a carcass work-up or slaughter chamber, as is known in the art) 22 of the present invention comprises supporting sidewalls 32, which may be constructed inline, “L”-shaped, “U”-shaped, or any other shape depending on the particular use for the processing chamber 22. The sidewalls 32 may be constructed of concrete, cinder blocks, bricks or other similar masonry, and a floor 34 preferably constructed of split-pavers as is well known in the art. It should be noted, however, that alternative constructions of the floor 34, including cement, gratings or any USDA-FDA approved material, are within the scope of the present invention. The sidewalls 32 support a plurality of cross-beams 36 which in turn support a center support beam 38. Stainless steel panels 40 are attached to the center support beam 38 to form a stainless steel ceiling. Alternatively, the ceiling can also be constructed of a single rounded, or semi-cylindrical panel as shown in FIG. 2. The sidewalls 32 preferably comprise top panels 42 and bottom panels 44. The top panels 42 are joined to the ceiling panels 40 and the bottom panels 44 are joined to the floor 34 to make the slaughter chamber 22 preferably water impermeable, and alternatively water resistant. Dimensions of the slaughter chamber 22 will vary depending on the edible product being processing, including fruits, vegetable and carcasses. While it is preferable that ceiling panels 40 and side panels 42 and 44 are constructed of stainless steel, it is well within the scope of the present invention to construct each panel 40, 42 and 44 of various other materials including, but not limited to, aluminum or any other USDA-FDA approved material.

Preferably, the floor 34 is provided with a continuous gutter drain 46, with strategically located drain points. These drains are connected to a process drainage system 48. The drain system 48 of the slaughter chamber 22 may be designed to match any general guideline directed by the United States Department of Agriculture, the Food Safety Inspection Service or any other regulating body for food safety. The floor 34 has the same grade throughout, having a sloped center gutter 46 connected to the drainage system 48.

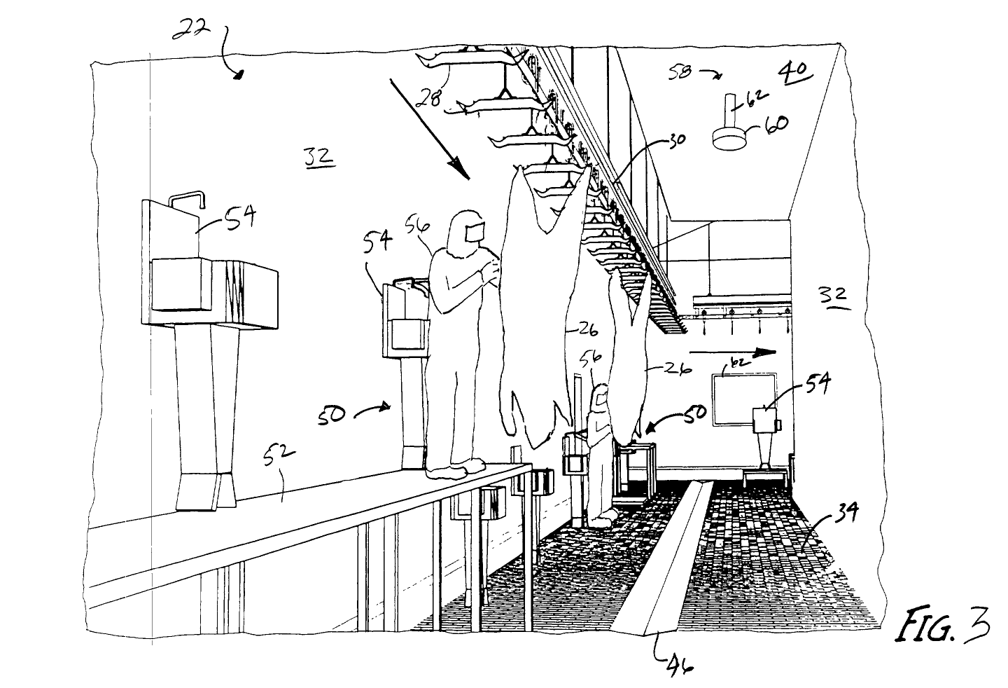

Referring to FIG. 1, the slaughter chamber 22 further includes a plurality of work stations 50 at which workers perform a variety of tasks on the edible products. When disemboweling or eviscerating carcass 26, these stations 50 are located at various positions and heights throughout the processing chamber 22. The work stations 50 are either located on the floor 34 or on a raised platform 52, and may include tables on which sets the edible product to be processed. Preferably, each work station is constructed of stainless steel, but also may be manufactured from food grade plastic. Sinks 54 constructed of either stainless steel or food grade plastic indicate the general area where a worker stands to perform the selected task upon the carcass 26. FIG. 3 includes a depiction of two carcasses 26 hanging from the hanging system 28 on the overhead conveyer 30, with workers 56 performing different tasks upon on the carcass 26 at each station 50. Such tasks include, but are not limited to, leaf pulling, eviscerating, and splitting. The inspections include the head inspector, viscera and rail inspection. In operation, the carcass 26 is transported by the overhead conveyer system 30 past a worker 56. The worker stops the carcass 26, performs a selected task upon the carcass 26, and then the carcass 26 passes to the next station 50. The worker need not travel with the carcass 26 because of the design of the “walking-beam” overhead conveyer system 30.

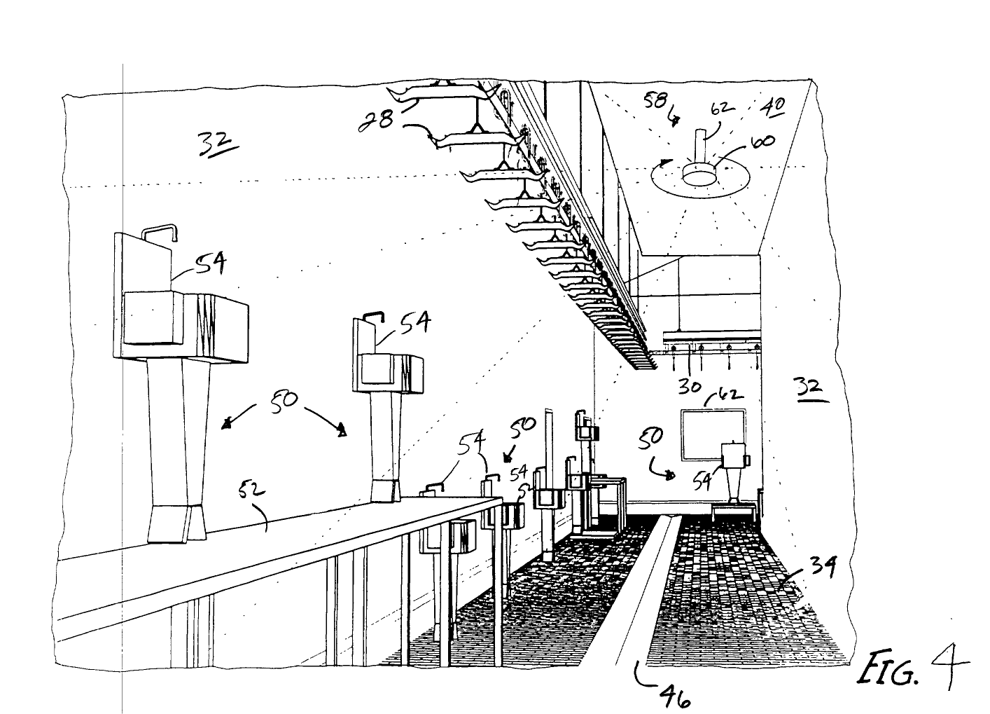

The slaughter chamber 22 further comprises an automated washing system 58 for removing waste products at regular intervals from the slaughter chamber 22, thus improving sanitary conditions of the processing facility 10. The automated washing system 58 preferably comprises a plurality of nozzles 60 attached to a water conduit 62 running outside the slaughter chamber 22. Preferably each nozzle 60 may rotate, emitting a pressurized jet of water in various directions to clean the inside of the slaughter chamber, as best illustrated in FIG. 4. Upon pumping water through the conduit 62, each nozzle 60 spews out a jet of water in various directions, increasing the effectiveness and thoroughness of the washing system 58. Water pressure supplied to each nozzle 60 may be within the range of 5 to 2,500 pounds per square inch depending on the application of a foaming agent, water or cleaning agent. Preferably, water pressure is above 50 pounds per square inch, and more preferably between 1,200 to 1,500 pounds per square inch. The spray nozzles 60 are strategically located to provide the most efficient wash-down process, utilizing large and small nozzles. Alternatively, it would be within the scope of the present invention to position a plurality of stationary nozzles 60 within the slaughter chamber, each nozzle 60 directed at a specific point, such as a ceiling panel 40, the floor 34 or wall panel 42 or 44, or at a specific work station 50.

The slaughter chamber 22 is a self-contained chamber, with the stainless steel construction of the ceiling panels 40 and sidewall panels 42 and 44 preventing contamination of waste products and water into other areas of the livestock processing facility 10. Apertures 64 are located throughout the slaughter chamber 22 to position light fixtures, utility outlets and spray nozzles 60 at strategic locations. The slaughter chamber 22 may be constructed in various configurations, including various widths, lengths, heights, and shapes, depending on the facility and the preferred process to be utilized.

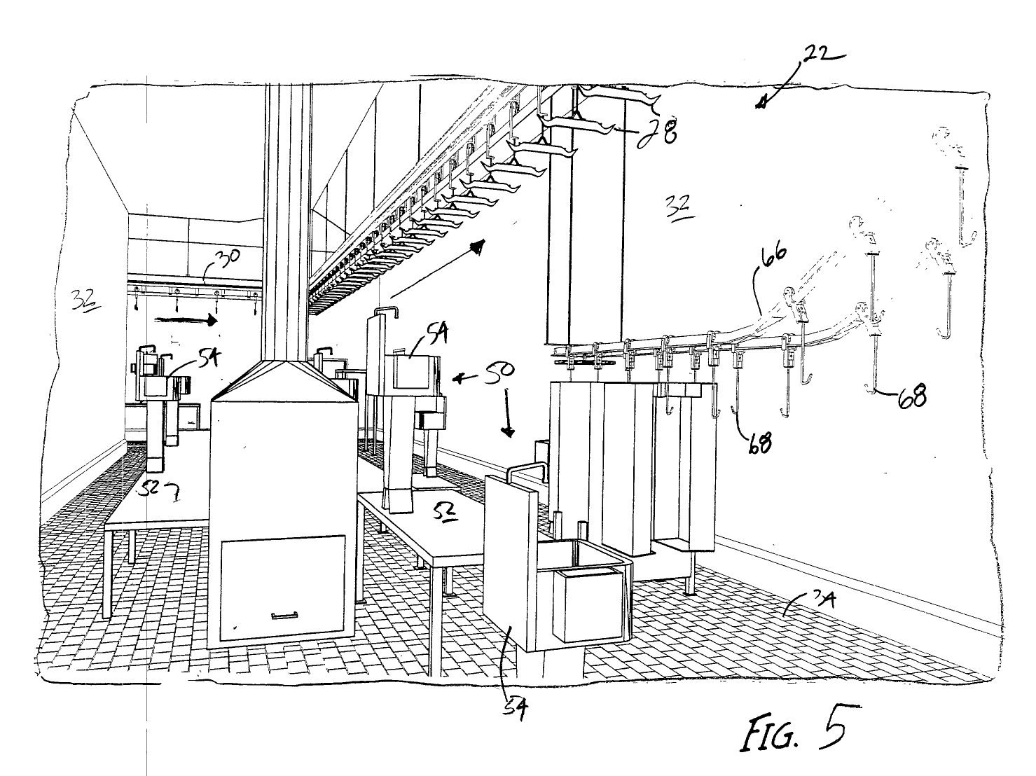

The slaughter chamber 22 further comprises a second overhead conveyer system 66, as best illustrated in FIG. 5. The second conveyor system 66 comprises a series of hooks 68 for attaching certain body parts harvested from each carcass 26. The hooks 68 carry the harvested body part, by way of the second overhead conveyer system 66, to the offal room 24 or packaging area 18 of the facility 10 where the harvested part can be further processed or packaged for shipment.

For sanitation reasons, the slaughter chamber 22 is periodically washed and sterilized to remove bodily material and fluids generated by disemboweling the carcasses 26. These bodily materials and fluids can contaminate other carcasses 26 traveling through the evisceration portion 22 by either direct contact or by airborne micro-organisms. With the present invention, the cleaning and sterilization of the slaughter chamber 22 can be accomplished quickly and effectively. Preferably, there are two multi-step cycles for cleaning and sterilization that include mid-shift cycles performed two or three times a day and an end-of-shift cycles performed once a day or five times a week.

To operate the automatic, self-cleaning system 58, introduction of additional carcasses 26 into the slaughter chamber 22 is momentarily stopped, and the remaining carcasses 26 already within the slaughter chamber 22 are processed past each of the stations 50. Each worker then exits the slaughter chamber area 22. A four cycle cleaning system is then initiated. Pumps (not shown) connected to the conduits 62 located outside the slaughter chamber 22 are activated.

During mid-shift cycles, pumps supply the nozzles 60 with water to flush the immovable objects within the chamber, which include the ceiling panels 40, sidewall panels 42 and 44, the floor 34, the work stations 50 and sinks. Immovable objects may also include any objects within the chamber 22 used during processing that are not easily removed from the chamber 22, including tables (not shown), the hanging system 28, and conveying systems 58 and 66. The first cycle flushes the chamber 22 and immovable objects for about a minute with raw, cold water. Upon flushing, the second cycle begins washing down the chamber 22 and immovable objects. The second cycle lasts approximate a minute and includes a cleaning agent being pumped through the nozzles 60 at approximately 110° F. The cleaning agent is directed onto the same items as did the previous cycle to flush the slaughter chamber 22.

Upon washing, the third cycle is initiated wherein water at approximately 185° F. is pumped through the system for about half a minute to sterilize the ceiling 40, floor 34, sidewalls 42 and 44 and work stations 50 of the slaughter chamber 22. Preferably, the first and third cycles use a substantially aqueous solution to flush and rinse the slaughter chamber 22. However, it is well within the scope of the present invention to use other solutions, which include, but are not limited to, sanitation solutions, anti-bacterial solutions, chlorinated solutions such as bleach, bromine solutions, and any USDA-FDA approved agent. Additionally, the term cleaning agent as used herein means any type of solution, including an aqueous solution, that will aid in the removal of surface debris including, but not limited to, detergents, soap, bleach, and any USDA-FDA approved agent.

Finally, the fourth part of the mid-shift cycles includes dry air being pumped through the slaughter chamber 22 to remove excess water. The air may be heated to increase its water retaining capacity. The temperature of the dry air will vary based upon volume of airflow provided and conditions of supply air such as humidity. After being sent through the processing chamber, the drying air can either be vented to the atmosphere or used elsewhere in the processing facility 10. Upon completion of the fourth cycle, the slaughter chamber 22 is ready for workers to re-enter and resume processing carcasses.

The end-of-shift cycles include five cycles, with the fifth cycle preferably occurring once per week, unless otherwise directed by quality assurance personnel or USDA-FDA regulations. Similar to the first mid-shift cycle, the end-of-shift cycle begins with a one minute flush of cold water to remove debris within the chamber and the immovable objects. The second cycle then directs a cleaning agent, such as a foam, within the chamber and onto the immovable objects for approximately a minute. The foam is emitted at a low pressure and then allowed to soak for approximately three minutes during the third cycle. The fourth cycle then spews water at approximately 185° F. within the chamber and onto the immovable objects for half a minute. This sterilizes the chamber 22. After a three minute cooling period, the chamber and immovable objects are then sprayed with sanitizing agent at 110° F., and allowed to dry.

The self-containment of the slaughter chamber 22 ensures that all the of water, bodily matter and fluids exit the slaughter chamber 22 during wash down through the drainage system 48, thus preventing any other areas of the processing facility 10 from being contaminated with the aforementioned waste products. These waste products, which include the contaminants along with the water emitting from the nozzles 60, wash and flow into the drainage system 48. From there, the waste products gravitationally flow toward the waste removal area 14. Preferably, the cleaning cycle is repeated at a regular interval of four hours, and should last between 10-15 minutes, which can easily be correlated to correspond with the workers' break time. Thus, when all of the workers leave for a lunch or coffee break, the slaughter chamber can be cleaned and sanitized in about 10-15 minutes, and be ready for processing of additional carcasses when the workers come back from break.

Although the present invention has been described with reference to preferred embodiments, workers skilled in the art will recognize that changes may be made in form and detail without departing from the spirit and scope of the invention.

1. A food processing chamber effective for workers to perform therein a selected task upon an edible product, the processing chamber comprising:
a floor;
walls joined to the floor;
a ceiling, the ceiling joined to the walls; and
a washing system supported by either the floor, the walls and/or the ceiling;
wherein the washing system directs a pressurized fluid toward at least one immovable object within the processing chamber in the absence of the workers, the pressurized fluid sanitizing the at least one immovable object.

2. The processing chamber of claim 1 wherein the pressurized fluid is at least 180° F. to sterilize at least one immovable object.

3. The processing chamber of claims 2 wherein the washing system directs the pressurized fluid toward the at least one immovable object at at least about 50 pounds per square inch.

4. The processing chamber of claims 2 wherein the washing system directs the pressurized fluid toward the at least on immovable object at about 1,200 to about 1,500 pounds per square inch.

5. The processing chamber of claims 1 wherein the washing system directs the pressurized fluid toward the at least one immovable object at at least about 50 pounds per square inch.

6. The processing chamber of claims 1 wherein the washing system directs the pressurized fluid toward the at least on immovable object at about 1,200 to about 1,500 pounds per square inch.

7. The processing chamber of claim 1 and further comprising a drainage system disposed within the floor, the drainage system effective for removing the pressurized fluid from the processing chamber.

8. The processing chamber of claim 1 wherein the washing system comprises:
a nozzle, the nozzle positioned within the processing chamber to direct the pressurized fluid toward the at least one immovable object;
a pumping system, the pumping system supplying the nozzle with the pressurized fluid; and
a conduit, the conduit connecting the nozzle to the pumping system.

9. The processing chamber of either claim 1 wherein the at least one immovable object includes a floor portion, a ceiling portion, a wall portion, a work station, a sink, or a standing platform.

10. A carcass work-up chamber for use in a livestock processing facility, the carcass work-up chamber comprising:
a floor;
a first sidewall joined to the floor;
a second sidewall joined to the floor;
a ceiling joined to the first sidewall and the second side-wall; and
a washing system supported by the floor, the first sidewall, the second sidewall and/or the ceiling; and
wherein the washing system directs pressurized fluid toward at least one object within the chamber in the absence of workers, the pressurized fluid removing debris and sanitizing the at least one object.

11. The carcass work-up chamber of the claim 10 and further comprising a drainage system disposed within the floor wherein the pressurized fluid and debris exit the chamber through the drainage system.

12. The carcass work-up chamber of claim 10 wherein the temperature of the pressurized fluid is at least 180° F.

13. The carcass work-up chamber of claim 10 wherein the washing system directs the pressurized fluid toward the at least one object at at least about 1000 pounds per square inch.

14. The carcass work-up chamber of claim 13 wherein the washing system directs the pressurized fluid toward the at least one object at about 1200 to about 1500 pounds per square inch.

15. The carcass work-up chamber of claim 10 wherein the washing system comprises:
a nozzle, the nozzle positioned within the processing chamber to direct the pressurized fluid toward the at least one object;
a pumping system, the pumping system supplying the nozzle with the pressurized fluid; and
a conduit, the conduit connecting the nozzle to the pumping system.

16. The carcass work-up chamber of claim 15 wherein the nozzle is positionably mobile to direct the pressurized fluid toward the at least one object.

17. The carcass work-up chamber of the claim 10 wherein the at least one object includes a floor portion, a ceiling portion, a wall portion, a work station, a sink, or a standing platform.

18. A method of sterilizing an enclosed area where workers perform a selected task upon an edible product, the method comprising the steps of:
exiting the workers from the enclosed area;
directing a pressurized fluid toward at least one immovable object within the enclosed area, the pressurized fluid sanitizing the immovable object;
directing workers to re-enter the enclosed area; and
repeating each step at a regular interval.

19. The method of claim 18 and further comprising the steps of directing a cleaning agent toward the at least one immovable object.

20. The method of claim 19 and further comprising the step of removing the pressurized fluid and the cleaning agent or debris through a drainage system.

21. The method of claim 18 and further comprising the step of drying the enclosed area by blowing dry air throughout the enclosed area.

22. The method of claim 18 wherein a regular interval occurs about every four hours of operation.

23. The method of claim 18 and further comprising the steps of activating a pumping system to supply the pressurized fluid.

24. The method of claim 18 and further comprising the steps of:
flushing the enclosed area with a first fluid;
washing the enclosed area with a second fluid, the second fluid directed toward the at least one immovable object; and
rinsing the enclosed area with a third fluid.

25. The method of claim 24 wherein either the first fluid, the second fluid or the third fluid is pressurized.

26. The method of claim 24 wherein the second fluid includes a cleaning agent.

27. The method of claim 26 wherein a cleaning agent includes detergent, bleach or soap.

28. The method of claim 18 wherein the pressurized fluid is at least 180° F.

29. The method of claim 18 wherein the at least one immovable object includes a floor portion, a ceiling portion, a wall portion, a work station, a sink, a table or a standing platform.
